(19) United States
(12) Patent Application Publication
(10) Pub. No.: US 2010/0277586 A1
(43) Pub. Date: Nov. 4, 2010

(54) Method and apparatus for updating background

(75) Inventors: Huang Ying, Beijing (CN); Lei Wang, Beijing (CN); Donghai Xie, Beijing (CN)

Correspondence Address: SILICON VALLEY PATENT AGENCY, 7394 WILDFLOWER WAY, CUPERTINO, CA, 95014, US

(73) Assignee: Vimicro Corporation

(21) Appl. No.: 12/475,526

(22) Filed: May 31, 2009

(30) Foreign Application Priority Data
May 1, 2009 (CN) 200910076465.4

(51) Int. Cl. H04N 7/18

(52) U.S. Cl. 348/143

(57) ABSTRACT

Techniques for updating background in a video surveillance system are disclosed. According to one aspect of the present invention, a background frame is obtained before detecting motion. An absolute value of a difference between a pixel of the current frame image and a corresponding pixel of the current background frame is calculated; a probability density of the one pixel of the current frame image is calculated to update the corresponding pixel of the current background frame according to the one pixel of the current frame image, unless the absolute value is larger than a difference threshold and the probability density is less than a probability density threshold.

### BACKGROUND OF THE INVENTION

1. Field of the Invention

The present invention relates to the area of video surveillance, more particularly to method and apparatus for updating background in a video surveillance system.

2. Description of Related Art

Intelligent video surveillance and retrieval systems have been developed to an extent that they may be readily used in nearly all applications and areas. Moving object detection and tracking techniques are probably mostly used in an intelligent video surveillance and retrieval system.

Moving points or pixels in images should be detected first when detecting motions. Generally, a first frame image of a video sequence is used as a background frame. The background frame is subtracted from each subsequent frame image to obtain the moving points. One disadvantage of this method is that an accuracy of the moving detection is degraded if there are moving objects in the first frame image. For example, the first frame image has a moving object x at an area Ax, the moving object x moves to an area Bx in the second frame image, and the area Ax and the area Bx do not overlap each other. After the background frame is subtracted from the second frame image, both the area Ax and the area Bx are determined as the foreground areas. In fact, the area Ax is not a foreground area, but a background area. Thus, it is likely to make an erroneous decision in detecting motion.

Thus, improved techniques for method and device for updating or initializing background in moving detection are desired to overcome the above disadvantages.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

In general, the present invention pertains to for updating background in a video surveillance system. According to one aspect of the present invention, a background frame is obtained before detecting motion. An absolute value of a difference between a pixel of the current frame image and a corresponding pixel of the current background frame is calculated; a probability density of the one pixel of the current frame image is calculated to update the corresponding pixel of the current background frame according to the one pixel of the current frame image, unless the absolute value is larger than a difference threshold and the probability density is less than a probability density threshold.

The present invention has many objects, advantages and benefits that will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1 is a flow chart showing a method for updating or initializing background in moving detection according to a first embodiment of the present invention;

FIG. 2 is a flow chart showing the method for updating or initializing background in moving detection according to a second embodiment of the present invention;

FIG. 3 is a block diagram showing an exemplary configuration of a background updating or initializing device according to the first embodiment of the present invention; and

FIG. 4 is a block diagram showing an exemplary configuration of the background updating or initializing device according to the second embodiment of the present invention.

### DETAILED DESCRIPTION OF THE INVENTION

The detailed description of the present invention is presented largely in terms of procedures, steps, logic blocks, processing, or other symbolic representations that directly or indirectly resemble the operations of devices or systems contemplated in the present invention. These descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams or the use of sequence numbers representing one or more embodiments of the invention do not inherently indicate any particular order nor imply any limitations in the invention.

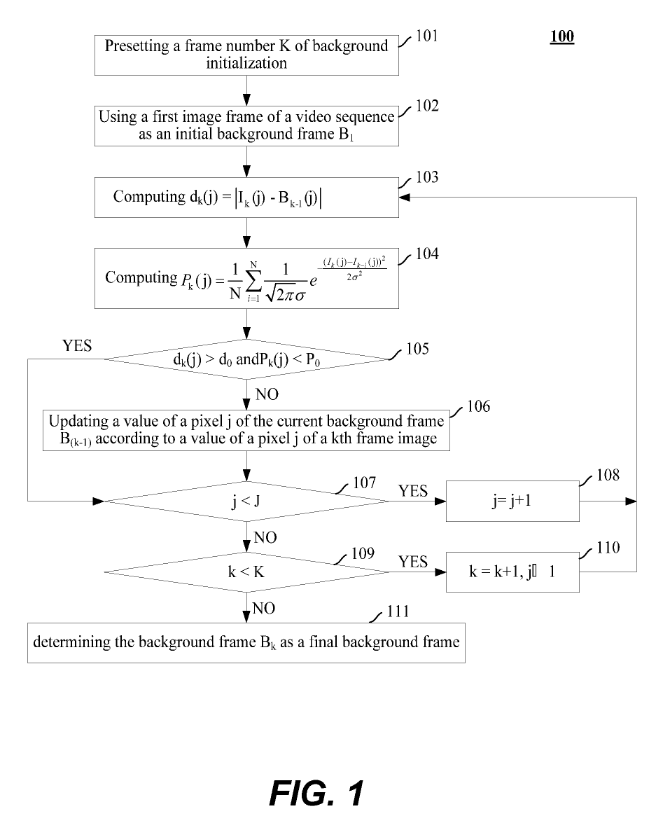

Embodiments of the present invention are discussed herein with reference to FIGS. 1-4. However, those skilled in the art will readily appreciate that the detailed description given herein with respect to these figures is for explanatory purposes only as the invention extends beyond these limited embodiments.

A background frame should be obtained before detecting motion. Different from the prior art, a final background frame for moving detection is established with reference to each frame image of a video sequence during background initialization in the present invention. FIG. 1 is a flowchart or process of updating or initializing background in moving detection according to a first embodiment of the present invention. Referring to FIG. 1, the process 100 comprises the following operations.

At 101, a frame number K of background initialization is set, where K is a positive integer and generally 100≦K≦500. In other words, it requires K frame images to generate the final background frame.

At 102, a first frame image of a video sequence is used as an initial background frame B₁. It should be noted that the initial background frame B₁ and following background frames Bₖ₋₁ are temporary background frames during background initialization. The temporary background frames are not used to detect moving objects in moving detection, but used to generate the final background frame.

For each pixel j of a kth frame image of the video sequence, the following operations are preformed repeatedly, wherein j is a positive integer, 1≦j≦J, J is a total pixel number in one frame image, and 2≦k≦K.

At 103, dₖ(j)=|Iₖ(j)−Bₖ₋₁(j)| is computed, wherein Iₖ(j) is a value of a jth pixel of the kth frame image of the video sequence, Bₖ₋₁(j) is a value of a jth pixel of a current background frame Bₖ₋₁, and dₖ(j) is an absolute value of a difference between Iₖ(j) and Bₖ₋₁(j). The smaller the value of dₖ(j) is, it is indicated that the higher the probability of the pixel j of the kth frame image being a background pixel is. On the contrary, the larger the value of dₖ(j) is, it is indicated that the higher the probability of the pixel j of the kth frame image being a foreground pixel is. The current background frame Bₖ₋₁ is same with the initial background frame B₁ when k=2.

At 104,

$${P}_{k} ( j ) = \frac{1}{N} {\sum }_{i = 1}^{N} \frac{1}{\sqrt{2 π} σ} {e}^{- \frac{{( {I}_{k} ( j ) - {I}_{k - i} ( j ) )}^{2}}{2 {σ}^{2}}}$$

is computed. where Pₖ(j) is a probability density of the jth pixel of the kth frame image, Iₖ₋ᵢ(j) is a value of a jth pixel of the (k−i)th frame image, N is a predefined positive integer and generally 8≦N≦32, σ is a predefined constant and generally 16≦σ≦128.

The larger the value of Pₖ(j) is, it is indicated that the smaller the difference between the value of the jth pixel of the kth frame image and the values of the jth pixels of the previous N−1 frame images is, namely the smaller the changes of the value of the jth pixels in the continuous N frame images is, so the higher the probability of the pixel j of the kth frame image being a moveless pixel is. On the contrary, the smaller the value of Pₖ(j) is, it is indicated that the larger the changes of the value of the jth pixels in the continuous N frame images is, so the higher the probability of the pixel j of the kth frame image being a moving pixel is.

At 105, it is determined whether dₖ(j)>d₀ and Pₖ(j)<P₀ are satisfied simultaneously, wherein d₀ is called as a difference threshold, P₀ is called as a probability density threshold, and d₀ and P₀ may be set according to experience. If yes, the value of the pixel j of the current background frame Bₖ₋ᵢ doesn't require to be updated, so Bₖ(j)=Bₖ₋₁(j), then the process 100 is taken to 107; otherwise, the process 100 is taken to 106.

At 106, the value of the pixel j of the current background frame Bₖ₋₁ is updated according to the value of the pixel j of the kth frame image. In one embodiment, the following formula is used to update the value of the pixel j of the background frame B₍ₖ₋₁₎:

Bₖ(j)=(1−α)Bₖ₋₁(j)+αIₖ(j)

where Bₖ(j) is a value of a pixel j of a next background frame Bₖ after the current background frame Bₖ₋₁ is updated, α is a predefined constant and generally 0.001≦α≦0.5.

At 107, it is determined whether j is less than J. If yes, that means that some pixels of the kth frame image have not been processed, the process 100 is taken to 108, where j is added by 1, and then the process 100 returns to 103; otherwise, that means that all pixels of the kth frame image have been processed, the process 100 is taken to 109.

At 109, it is determined whether k is less than K. If yes, that means that the background initialization is not over, the process 100 is taken to 110; otherwise, that means that the background initialization is over, the process 100 is taken to 111. At 110, k=k+1 and j=1, and then the process 100 returns to 103. At 111, the updated background frame Bₖ is determined as the final background frame.

As described above, only when the value of dₖ(j) is larger than the difference threshold do and the value of Pₖ(j) is less than the probability density threshold p₀ for each pixel j of the frame image Iₖ of the video sequence, the pixel j of the current background frame Bₖ₋₁ doesn't require to be updated; otherwise, the pixel j of the current background frame Bₖ₋₁ requires to be updated. In other words, only when the pixel of the frame image is the foreground pixel and the moving pixel, the pixel of the current background frame doesn't require to be updated, thereby improving stability of the background update.

After the final background frame is obtained, the moving detection can be performed to detect moving objects in the following video sequence according to the final background frame. At the same time, the final background frame still requires to be updated continuously according to the frame image of the following video sequence. When an absolute value of a difference between a value of the pixel j of the frame image Iₘ and a value of the pixel j of the final background frame Bₘ₋₁ is larger than a difference threshold d₁, the pixel j of the final background frame Bₘ₋₁ doesn't require to be updated; otherwise, the pixel j of the final background frame Bₘ₋₁ requires to be updated according to the pixel j of the frame image Iₘ. Iₘ is the mth frame image of the following video sequence, Bₘ₋₁ is the final background frame Bₘ₋₁ of the mth frame image, m is a positive integer and larger than 2. Thereby, the update to the final background frame is simplified. The final background frame Bₘ₋₁ is the final background frame Bₖ determined in FIG. 1 when m=2. The pixel j of the final background frame Bₘ₋₁ is updated according to the following formula:

Bₘ(j)=(1−α)Bₘ₋₁(j)+αIₘ(j)

where Bₘ₋₁(j) is a value of the pixel j of the final background frame Bₘ₋₁, Bₘ(j) is a value of the pixel j of the updated final background frame Bₘ, Iₘ(j) is a value of the pixel j of the mth frame image of the following video sequence.

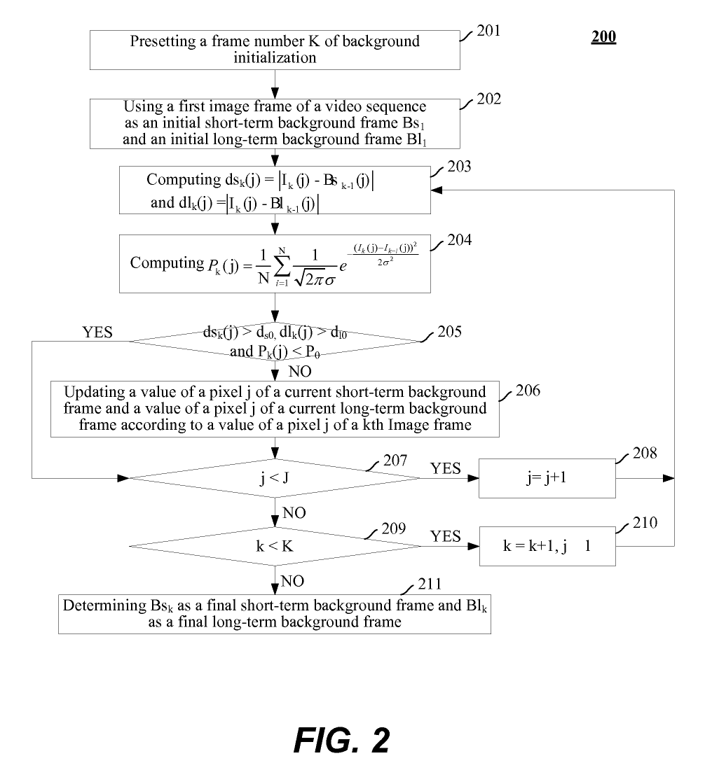

FIG. 2 is a flow chart showing the method 200 for updating or initializing background in moving detection according to a second embodiment of the present invention. Referring to FIG. 2, the method 200 comprises the following operations.

At 201, a frame number K of background initialization is set, wherein K is a positive integer and generally 100≦K≦500. At 102, a first frame image of a video sequence is used as an initial short-term background frame Bs₁ and an initial long-term background frame Bl₁.

For each pixel j of a kth frame image of the video sequence, the following operations are preformed repeatedly, wherein j is a positive integer, 1≦j≦J, J is a total pixel number in each frame image, and 2≦k≦K.

At 203, dsₖ(j)=|Iₖ(j)−Bsₖ₋₁(j)| and dlₖ(j)=|Iₖ(j)−Blₖ₋₁(j)| are computed, wherein Iₖ(j) is a value of a jth pixel of the kth frame image, Bsₖ₋₁(j) is a value of a jth pixel of a current short-term background frame Bsₖ₋₁, and dsₖ(j) is an absolute value of a difference between Iₖ(j) and Bsₖ₋₁(j), Blₖ₋₁(j) is a value of a jth pixel of a current long-term background frame Blₖ₋₁, and dlₖ(j) is an absolute value of a difference between Iₖ(j) and Blₖ₋₁(j).

033 The smaller the values of dsₖ(j) and dlₖ(j) are, it is indicated that the higher the probability of the pixel j of the kth frame image being a background pixel is. On the contrary, the larger the values of dsₖ(j) and dlₖ(j) are, it is indicated that the higher the probability of the pixel j of the kth frame image being a foreground pixel is. The current long-term background frame Blₖ₋₁ is the initial background frame Bl₁ when k=2, and the current short-term background frame Bsₖ₋₁ is the initial background frame Bs₁ when k=2.

At 204,

$${P}_{k} ( j ) = \frac{1}{N} {\sum }_{i = 1}^{N} \frac{1}{\sqrt{2 π} σ} {e}^{- \frac{{( {I}_{k} ( j ) - {I}_{k - i} ( j ) )}^{2}}{2 {σ}^{2}}}$$

is computed. where, Pₖ(j) is a probability density of the value of the jth pixel of the kth frame image, Iₖ₋ᵢ(j) is a value of a jth pixel of the (k−i)th frame image, N is a predefined positive integer and generally 8≦N≦32, σ is a predefined constant and generally 16≦σ≦128.

The larger the value of Pₖ(j) is, it is indicated that the smaller the difference between the value of the jth pixel of the kth frame image and the values of the jth pixels of the previous N−1 frame images is, namely the smaller the changes of the value of the jth pixels in the continuous N frame images is, so the higher the probability of the pixel j of the kth frame image being a moveless pixel is. On the contrary, the smaller the value of Pₖ(j) is, it is indicated that the larger the changes of the value of the jth pixels in the continuous N frame images is, so the higher the probability of the pixel j of the kth frame image being a moving pixel is.

At 205, it is determined whether dsₖ(j)>ds₀, dlₖ(j)>dₗ₀ and Pₖ(j)<P₀ are satisfied simultaneously, wherein dₛ₀ is called as a short-term difference threshold, dₗ₀ is called as a long-term difference threshold, P₀ is called as a probability density threshold, and dₛ₀, dₗ₀ and P₀ may be set according to experience. If yes, the values of the pixels j of the current short-term background frame Bsₖ₋₁ and the current long-term background frame Blₖ₋₁ do not require to be updated, so Bsₖ(j)=Bsₖ₋₁(j) and B1ₖ(j)=B1_{k 1}(j), then the process 200 is taken to 207; otherwise, the process 200 is taken to 206.

At 206, the values of the pixels j of the current short-term background frame Bsₖ₋₁ and the current long-term background frame Blₖ₋₁ are updated according to the value of the pixel j of the kth frame image.

In one embodiment, the following formula is used to update the value of the pixel j of the current short-term background frame Bsₖ₋₁:

Bsₖ(j)=(1−αₛ)Bsₖ₋₁(j)+αₛIₖ(j)

where Bsₖ(j) is a value of a pixel j of a next short-term background frame after the current short-term background frame Bsₖ₋₁ is updated, αₛ is a predefined constant and generally 0.1≦αₓ≦0.5.

In one embodiment, the following formula is used to update the value of the pixel j of the current long-term background frame Bl₍ₖ₋₁₎:

B1ₖ(j)=(1−α)B1ₖ₋₁(j)+α₁Iₖ(j)

where B1ₖ(j) is a value of a pixel j of a next long-term background frame after the current long-term background frame Blₖ₋₁ is updated, α₁ is a predefined constant and generally 0.001≦α₁≦0.1.

It can be seen that the update formula of the short-term background frame is identical with that of the long-term background frame except for α. When updating the short-term background frame, α=αₛ, wherein the value of αₛ is larger. When updating the long-term background frame, α=α₁, wherein the value of α₁ is smaller.

At 207, it is determined whether j is less than J. If yes, that means that some pixels of the kth frame image have not been processed, the process 200 is taken to 208, where j is added by 1 and then the process 200 returns to 203; otherwise, that means that all pixels of the kth frame image have been processed, the process 200 is taken to 209.

At 209, it is determined whether k is less than K. If yes, that means that the background initialization is not over, the process 200 is taken to 210; otherwise, that means that the background initialization is over, the process 200 is taken to 211. At 210, k=k+1 and j=1, and then the process 200 returns to 203. At 211, the short-term background frame Bsₖ is determined as the final short-term background frame, and the long-term background frame Blₖ is determined as the final long-term background frame.

Similar to the first embodiment, after the final long-term background frame and the final short-term background frame are obtained, the moving detection can be performed to detect moving objects in the following video sequence according to the final long-term background frame and the final short-term background frame. At the same time, the final long-term background frame and the final short-term background frame require to be updated continuously according to the frame image of the following video sequence.

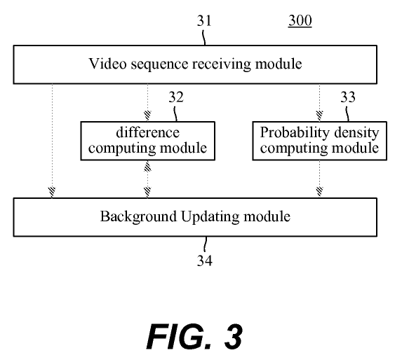

FIG. 3 is a block diagram showing an exemplary configuration of a background updating or initializing device 300 according to the first embodiment of the present invention. Referring to FIG. 3, the background updating or initializing device 300 comprises a video sequence receiving module 31, a difference computing module 32, a probability density computing module 33 and a background updating module 34.

The video sequence receiving module 31 is configured for providing a video sequence. The difference computing module 32 is configured for determining a current image frame from the video sequence, obtaining a current background frame from the background updating module 34, computing an absolute value of a difference between a value of each pixel of the current image frame and a value of corresponding pixel of the current background frame.

The probability density computing module 31 is configured for computing a probability density of each pixel of the current image frame. The background updating module 34 is configured for using a first image frame of the video sequence as an initial current background frame, updating corresponding pixel of the current background frame according to one pixel of the current image frame when the probability density of the one pixel of the current image frame is not less than a probability density threshold or/and the absolute value of the difference corresponding to the one pixel of the current image frame is not larger than a difference threshold. After all pixels of the current frame image are processed, the background frame is updated continuously by determining the updated current background frame as a new current background frame and determining a next image frame of the video sequence as a new current background until the background initialization is over. The updated current background frame finally got is determined as a final background frame.

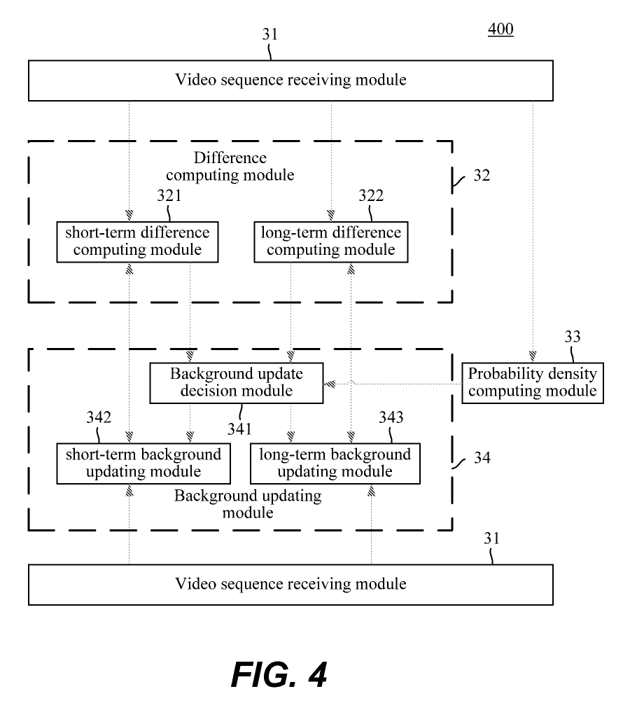

FIG. 4 is a block diagram showing an exemplary configuration of the background updating or initializing device according to the second embodiment of the present invention. The background updating device 400 is identical with the background updating device 300 except that the difference computing module 32 further comprises a short-term difference computing module 321 and a long-term difference computing module 322, and the background updating module 34 further comprises a background update decision module 341, a short-term background updating module 342 and a long-term background updating module 343.

The difference computing module 32 determines a current image frame from the video sequence. The short-term difference computing module 321 is configured for obtaining a current short-term background frame from the background updating module 34, computing an absolute value of a first difference between a value of each pixel of the current image frame and a value of corresponding pixel of the current short-term background frame. The long-term difference computing module 322 is configured for obtaining a current long-term background frame from the background updating module 34, computing an absolute value of a second difference between the value of each pixel of the current image frame and a value of corresponding pixel of the current long-term background frame.

The background update decision module 341 is configured to determine whether the probability density of one pixel of the current image frame being less than a probability density threshold, the absolute value of the first difference being larger than a first difference threshold, and the absolute value of the second difference being larger than a second difference threshold are satisfied simultaneously. If no, updating instructions are sent to the short-term background updating module 342 and the long-term background updating module 343, respectively.

The short-term background updating module 342 is configured for using a first image frame of the video sequence as an initial current short-term background frame, updating corresponding pixel of the current short-term background frame according to one pixel of the current image frame when the update instruction is received. The short-term background frame is updated continuously by determining the updated current short-term background frame as a new current short-term background frame and determining a next image frame of the video sequence as a new current background until the background initialization is over.

The long-term background updating module 343 is configured for using a first image frame of the video sequence as an initial current long-term background frame, updating corresponding pixel of the current long-term background frame according to one pixel of the current image frame when the update instruction is received. The long-term background frame is updated continuously by determining the updated current long-term background frame as a new current short-term background frame and determining a next image frame of the video sequence as a new current background until the background initialization is over.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

What is claimed is:

1. A method for updating a current background frame according to a current frame image, the comprising:
computing an absolute value of a difference between one pixel of the current frame image and corresponding pixel of the current background frame;
computing a probability density of the one pixel of the current frame image;
updating the corresponding pixel of the current background frame according to the one pixel of the current frame image unless the absolute value is larger than a difference threshold and the probability density is less than a probability density threshold.

2. The method according to claim 1, wherein the computing a probability density of the one pixel of the current frame image comprises: computing
$${P}_{k} ( j ) = \frac{1}{N} {\sum }_{i = 1}^{N} \frac{1}{\sqrt{2 π} σ} {e}^{- \frac{{( {I}_{k} ( j ) - {I}_{k - i} ( j ) )}^{2}}{2 {σ}^{2}}} ;$$
and
where j is a series number of the one pixel in the current frame image, k is a series number of the current frame image, Iₖ(j) is a value of the jth pixel of the kth frame image, Pₖ(j) is the probability density of the jth pixel of the kth frame image, Iₖ₋ᵢ(j) is a value of the jth pixel of the (k−i)th frame image, N is a predefined positive integer, and σ is a predefined constant.

3. The method according to claim 2, wherein the computing an absolute value of a difference between one pixel of the current frame image and corresponding pixel of the current background frame comprises:
computing dₖ(j)=|Iₖ(j)−Bₖ₋₁(j)|; and
wherein j also is a series number of the corresponding pixel in the current background frame, k−1 is a series number of the current background frame, Bₖ₋₁(j) is a value of the jth pixel of the current background frame, dₖ(j) the absolute value of the difference between Iₖ(j) and Bₖ₋₁(j).

4. The method according to claim 3, wherein the updating the corresponding pixel of the current background frame according to the one pixel of the current frame image comprises:
computing Bₖ(j)=(1−α)Bₖ₋(j)+αIₖ(j);
wherein, Bₖ(j) is a value of the jth pixel of an updated background frame, and α is a predefined constant.

5. The method according to claim 1, wherein the corresponding pixel of the current background frame is not required to be updated when the absolute value is larger than a difference threshold and the probability density is less than a probability density threshold.

6. The method according to claim 1, wherein each pixel of the current frame image is processed by the same way until all pixel of the current frame image is finished.

7. The method according to claim 6, wherein a next frame image of a video sequence is determined as the current frame image, the updated current background frame is determined as the current background frame, and then the current background frame is updated according to the current frame image continuously until a background initialization is over.

8. A method for updating a current short-term background frame and a current long-term background frame according to a current frame image, comprising:
computing an absolute value of a first difference between one pixel of the current frame image and corresponding pixel of the current short-term background frame;
computing an absolute value of a second difference between the one pixel of the current frame image and corresponding pixel of the current long-term background frame;
computing a probability density of the one pixel of the current frame image;
updating the corresponding pixel of the current short-term background frame and the corresponding pixel of the current long-term background frame according to the one pixel of the current frame image unless the absolute value of the first difference is larger than a first difference threshold, the absolute value of the second difference is larger than a second difference threshold and the probability density is less than a probability density threshold.

9. The method according to claim 8, wherein the computing a probability density of the one pixel of the current frame image comprises:
computing
$${P}_{k} ( j ) = \frac{1}{N} {\sum }_{i = 1}^{N} \frac{1}{\sqrt{2 π} σ} {e}^{- \frac{{( {I}_{k} ( j ) - {I}_{k - i} ( j ) )}^{2}}{2 {σ}^{2}}} ;$$
and
where j is a series number of the one pixel in the current frame image, k is a series number of the current frame image, Iₖ(j) is a value of the jth pixel of the kth frame image, Pₖ(j) is the probability density of the jth pixel of the kth frame image, Iₖ₋ᵢ(j) is a value of the jth pixel of the (k−i)th frame image, N is a predefined positive integer, and σ is a predefined constant.

10. The method according to claim 9, wherein
the computing an absolute value of a first difference between one pixel of the current frame image and corresponding pixel of the current short-term background frame comprises:
computing dsₖ(j)=|Iₖ(j)−Bsₖ₋₁(j)|; and
where j also is a series number of the corresponding pixel in the current short-term background frame, k−1 is a series number of the current short-term background frame, Bsₖ₋₁(j) is a value of the jth pixel of the current short-term background frame, dsₖ(j) the absolute value of the first difference between Iₖ(j) and Bsₖ₋₁(j);
the computing an absolute value of a second difference between one pixel of the current frame image and corresponding pixel of the current long-term background frame comprises:
computing dlₖ(j)=|Iₖ(j)−B1ₖ₋₁(j)|; and
wherein j also is a series number of the corresponding pixel in the current long-term background frame, k−1 is a series number of the current long-term background frame, Blₖ₋₁(j) is a value of the jth pixel of the current long-term background frame, dlₖ(j) the absolute value of the second difference between Iₖ(j) and Bsₖ₋₁(j).

11. The method according to claim 10, wherein
the updating the corresponding pixel of the current short-term background frame comprises:
computing Bsₖ(j)=(1−α)Bsₖ₋₁(j)+αₛIₖ(j);
wherein, Bsₖ(j) is a value of the jth pixel of an updated short-term background frame, and αₛ is a predefined constant;
the updating the corresponding pixel of the current long-term background frame comprises:
computing B1ₖ(j)=(1α₁)B1ₖ₋₁(j)+α₁Iₖ(j);
where B1ₖ(j) is a value of the jth pixel of an updated long-term background
frame, α₁ is a predefined constant, and αₛ>α₁.

12. The method according to claim 8, wherein the corresponding pixel of the current background frame is not required to be updated when the absolute value of the first difference is larger than a first difference threshold, the absolute value of the second difference is larger than a second difference threshold and the probability density is less than a probability density threshold.

13. An apparatus for updating a current background frame according to a current frame image, the device comprising:
a difference computing module configured for computing an absolute value of a difference between each pixel of the current frame image and corresponding pixel of the current background frame;
a probability density computing module configured for computing a probability density of each pixel of the current frame image;
a background updating module configured for updating corresponding pixel of the current background frame according to one pixel of the current frame image unless the absolute value pixel corresponding to the one pixel of the current frame image is larger than a difference threshold and the probability density of the one pixel of the current image is less than a probability density threshold.

14. The apparatus according to claim 13, wherein the current background frame comprises a current short-term background frame and a current long-term background frame, the difference computing module comprises a short-term difference computing module and a long-term difference computing module, and wherein
the short-term difference computing module is configured for computing an absolute value of a first difference between each pixel of the current frame image and corresponding pixel of the current short-term background frame;
the long-term difference computing module is configured for computing an absolute value of a second difference between the one pixel of the current frame image and corresponding pixel of the current long-term background frame.

15. The apparatus according to claim 14, wherein the background updating module comprises a short-term background updating module and a long-term background updating module, and wherein
the short-term background updating module is configured for updating the corresponding pixel of the current short-term background frame according to the one pixel of the current frame image unless the absolute value of the first difference is larger than a first difference threshold, the absolute value of the second difference is larger than a second difference threshold and the probability density is less than a probability density threshold; and
the short-term background updating module is configured for updating the corresponding pixel of the current long-term background frame according to the one pixel of the current frame image unless the absolute value of the first difference is larger than a first difference threshold, the absolute value of the second difference is larger than a second difference threshold and the probability density is less than a probability density threshold.
